(19) United States
(12) Patent Application Publication
(10) Pub. No.: US 2026/0071654 A1
(43) Pub. Date: Mar. 12, 2026

(54) DRIVE SHAFT FOR AN AIRCRAFT TURBOMACHINE

(71) Applicant: SAFRAN TRANSMISSION SYSTEMS, COLOMBES (FR)

(72) Inventors: Clémet Romain Aimé CADET, MOISSY-CRAMAYEL (FR); William YE, MOISSY-CRAMAYEL (FR); Victor PEREA, MOISSY-CRAMAYEL (FR); Mohamed BOUDHANI, MOISSY-CRAMAYEL (FR)

(73) Assignee: SAFRAN TRANSMISSION SYSTEMS, COLOMBES (FR)

(21) Appl. No.: 19/325,817

(22) Filed: Sep. 11, 2025

(30) Foreign Application Priority Data
Sep. 12, 2024 (FR) FR2409729

(51) Int. Cl. F16D 3/06; F01D 25/00

(52) U.S. Cl. CPC F16D 3/06; F01D 25/00; F05D 2240/60; F16D 2250/0084; F16D 2300/12; F16D 2300/22

(57) ABSTRACT

A drive shaft includes a male cylindrical body, a first splined section, and a second splined section. The first section is arranged coaxially around the male cylindrical body and has first longitudinal splines formed by alternating first teeth and first grooves. The first section is rotationally secured to the male cylindrical body. The second splined section is arranged coaxially around the male cylindrical body and has second longitudinal splines formed by alternating second teeth and second grooves. The second section is biased by an elastic element from a first position to a second position in which the second teeth are angularly offset relative to the first teeth.

### CROSS-REFERENCE TO RELATED APPLICATION

This application claims priority to FR 2409729, filed Sep. 12, 2024, the disclosure of which is hereby expressly incorporated by reference herein in its entirety.

### TECHNICAL FIELD

The disclosure relates to a drive shaft for an aircraft turbomachine. The disclosure relates in particular to a drive shaft with splines.

### BACKGROUND

An aircraft turbomachine generally extends along and around a longitudinal axis. It comprises a gas generator which typically comprises, from upstream to downstream, in the direction of gas flow in the turbomachine, a fan, a low-pressure compressor, a high-pressure compressor, a gas combustion chamber, a high-pressure turbine and a low-pressure turbine.

The low-pressure compressor rotor is typically connected to the rotor of the low-pressure turbine by means of a low-pressure shaft. The rotor of the high-pressure compressor is connected to the rotor of the high-pressure turbine by a high-pressure shaft.

The fan allows the suction of an air flow that is divided into a primary air flow passing through a primary duct and a secondary air flow passing through a secondary duct surrounding the primary duct. The primary air flow passes through the low-pressure and high-pressure compressors. The compressed primary air flow then passes through the combustion chamber, where it is mixed with a fuel. The combustion gases thus pass through the high-pressure and low-pressure turbines. The energy of the gases is converted by the turbine rotor of the low-pressure turbine into mechanical energy, which allows the low-pressure shaft to rotate and, consequently, the low-pressure compressor.

In addition, such a turbomachine comprises a plurality of accessories such as lubrication pumps, fuel pumps, or electrical power supply members necessary for the operation of the turbomachine and the aircraft. These accessories must also be supplied with power to operate.

In this case, part of the turbomachine's mechanical energy is extracted to power the accessories. The sample is typically taken from one of the shafts of the turbomachine, in particular the high-pressure shaft. Such sampling is performed by an accessory drive train (ADT). Such a drive train is also used for mechanical training of the turbomachine during start-up phases.

The accessory drive train typically comprises drive shafts which ensure the transmission of the rotational movement of the shafts of the turbomachine and the transfer of mechanical energy.

Each drive shaft extends along a longitudinal axis and typically comprises a male cylindrical body extending along the longitudinal axis and a female cylindrical body in which the male cylindrical body is coaxially engaged.

The male and female cylindrical bodies work together using a spline connection. Thus, the male cylindrical body comprises a section with longitudinal splines, and the female cylindrical body comprises an annular internal housing with internal longitudinal splines that cooperate with the splines of the male cylindrical body.

In some hybrid turbomachines, the accessory drive train is also used for energy injection phases. In such turbomachines, the accessory drive train alternates between energy injection and extraction phases. This alternation of extraction and injection phases generates dynamic over-torques within the drive shafts of the accessory drive train, resulting in greater mechanical clearances between the splines of the male and female cylindrical bodies. These clearances are responsible for loud rattling noises during the rotation of the drive shafts. This alternation between power extraction and injection phases also generates torque oscillations within the drive shafts.

These phenomena, which are particularly significant in hybrid turbomachines, can severely damage drive shafts.

In fact, there is a need to provide a drive shaft that allows limiting mechanical play within the drive shaft and reduces torque oscillations.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

To this end, the disclosure proposes a drive shaft for an aircraft turbomachine, the drive shaft having a longitudinal axis and comprising:
a male cylindrical body extending around and along the longitudinal axis,
a first splined section arranged coaxially around the male cylindrical body and having first longitudinal splines evenly distributed around the longitudinal axis and comprising alternating first teeth and first grooves, the first section being rotationally secured to the male cylindrical body.

The drive shaft is remarkable in that it further comprises:
a second splined section arranged coaxially around the male cylindrical body, the second section having second longitudinal splines evenly distributed around the longitudinal axis and comprising alternating second teeth and second grooves, the second section being biased by an elastic element from a first position to a second position in which the second teeth are angularly offset relative to the first teeth.

The disclosure may comprise one or more of the following characteristics, taken alone or in combination with each other:
the elastic element comprises at least one first spring mechanically connecting the first and second sections,
the elastic element comprises a second spring diametrically opposed to the first spring and mechanically connecting the first and second sections,
the first section comprises an annular lateral flank having at least a first housing for receiving the first spring and optionally a second housing for receiving the second spring,
in the second position, the second teeth are angularly offset by less than half a pitch relative to the first teeth, a pitch being the inter-tooth distance between two adjacent first teeth,
at least one axial abutment connected to the elastic means,
a third section arranged coaxially around the male cylindrical body, the third section having third longitudinal splines distributed around the longitudinal axis and comprising alternating third teeth and third grooves, the first section being arranged axially between the second and third sections, the third section being biased by a second elastic element from a first position to a second position in which the third teeth are angularly offset relative to the first teeth,
in the second position, the third teeth are angularly aligned with the second teeth, a female cylindrical body having an annular internal housing into which the male cylindrical body is inserted and longitudinal internal splines cooperating with the first and second splines, the internal splines comprising alternating internal teeth and internal grooves, the first teeth being inserted into the internal grooves and the second teeth filling an angular clearance defined between the first teeth and the internal teeth,
the second teeth are pressed against the internal teeth.

The disclosure also relates to a method of preparing a drive shaft according to any one of the preceding characteristics.

The method being further remarkable in that it comprises the following steps:
(a) providing the male cylindrical body on which the first section is located,
(b) supplying the second section, and
(c) biasing the elastic means to drive the second section from the first position to the second position.

The disclosure also relates to a method of mounting a drive shaft according to any one of the preceding characteristics.

The method being further remarkable in that it comprises the following steps:
(a′) preparing the drive shaft according to the previous preparation method,
(b′) providing the female cylindrical body, and
(c′) inserting the male cylindrical body into the female cylindrical body, the second teeth filling the clearance defined between the first teeth and the internal teeth.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a longitudinal sectional view of an example of an aircraft turbomachine according to the disclosure;

FIG. 2 is a schematic longitudinal sectional view of a drive shaft according to the disclosure, comprising a female cylindrical body and a male cylindrical body engaged in the female cylindrical body,

FIG. 3 is a cross-sectional view of the drive shaft in FIG. 2, along the plane A-A′,

FIG. 4 is a schematic view of the male cylindrical body in FIG. 2 in longitudinal section, showing the direction of assembly of the second and third splined sections,

FIG. 5 is a schematic perspective view of the first section of the male cylindrical body,

FIG. 6 is a schematic cross-sectional view of the second section of the male cylindrical body,

FIG. 7 is another schematic view of the male cylindrical body in longitudinal section,

FIG. 8 is a schematic cross-sectional view of the male cylindrical body along the plane B-B′, and

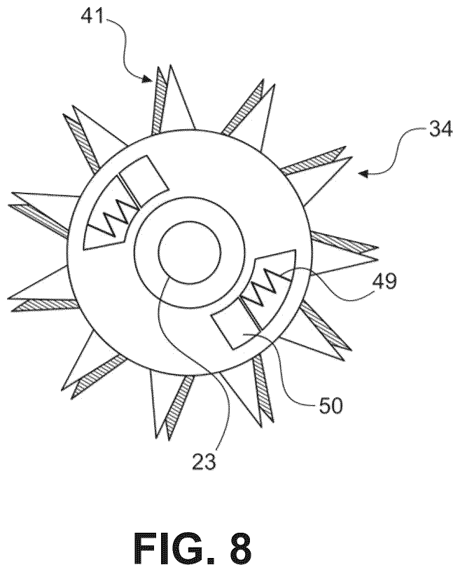

FIG. 9 is a side view of the second section of FIG. 6.

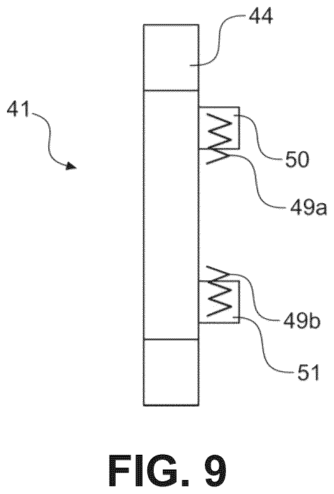

### DETAILED DESCRIPTION

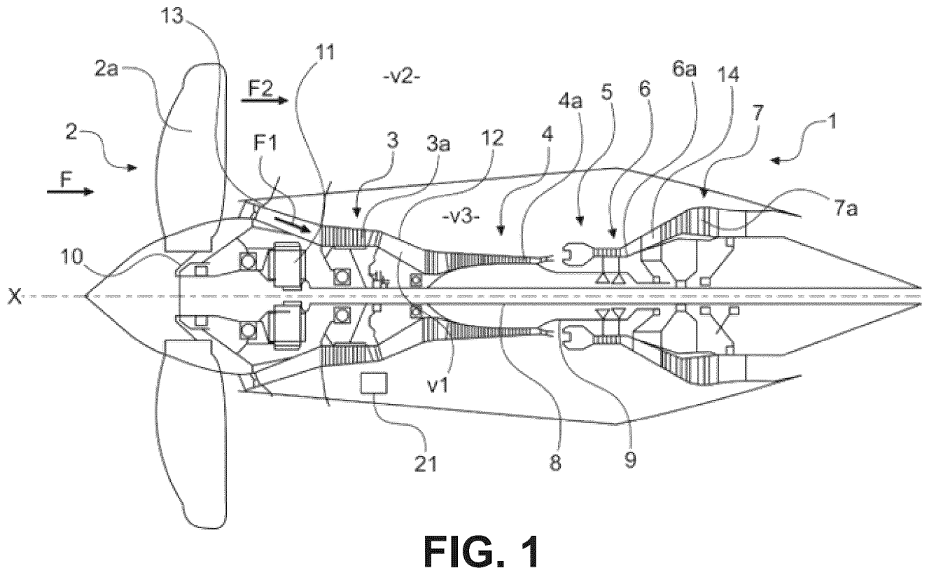

An example of an aircraft turbomachine 1 according to the disclosure is shown very briefly in FIG. 1. The turbomachine 1 is, for example, a turboprop engine.

The turbomachine 1 extends along a longitudinal axis X. An airflow F flows through the turbomachine 1.

For the purposes of the present disclosure, the terms “upstream” and “downstream” are understood in relation to the direction of flow of the air flow F in the turbomachine 1 along the longitudinal axis X.

The turbomachine 1 comprises, from upstream to downstream, a fan 2, a low-pressure compressor 3, a high-pressure compressor 4, a combustion chamber 5, a high-pressure turbine 6 and a low-pressure turbine 7.

Each compressor 3, 4 comprises a compressor rotor 3a, 4a and each turbine 6, 7 comprises a turbine rotor 6a, 7a. The compressor rotors 3a, 4a and turbine rotors 6a, 7a are made up of a plurality of stages, each comprising a bladed wheel.

The compressor rotor 3a of the low-pressure compressor 3 is connected to the turbine rotor 7a of the low-pressure turbine 7 by a low-pressure shaft 8. They form a low-pressure body.

The compressor rotor 4a of the high-pressure compressor 4 is connected to the turbine rotor 6a of the high-pressure turbine 6 by a high-pressure shaft 9. They form a high-pressure body.

The low-pressure shaft 8 and high-pressure shaft 9 are centered on the longitudinal axis X and movable in rotation about the longitudinal axis X. The high-pressure shaft 9 is arranged coaxially around the low-pressure shaft 8.

The air flow F passes through the fan 2 and divides into a primary flow F1 passing through a primary duct v1 and a secondary air flow F2 passing through a secondary duct v2 surrounding the primary duct. The primary air flow F1 passes through the low-pressure compressor 3 and the high-pressure compressor 4. The compressed primary air flow F1 then passes through the combustion chamber 5, where it is mixed with a fuel. The gases produced by combustion pass through the high-pressure turbine 6 and the low-pressure turbine 7. The energy in the gases is converted by the turbine rotor 7a of the low-pressure turbine 7 into mechanical energy allowing to drive in rotation the low-pressure shaft 8 and consequently the low-pressure compressor 3.

The fan 2 comprises a disc that is movable in rotation about the longitudinal axis X and vanes 2a evenly distributed over the disc. The fan 2, for example, is of the unducted type. In contrast to a ducted fan 2, the fan 2 does not comprise a fan casing surrounding the vanes 2a. In another example, not shown, the fan 2 is of the ducted type.

The disc is driven in rotation by a fan shaft 10. Advantageously, the fan shaft 10 is connected to the low-pressure shaft 8, for example via a speed reduction gear 11. The speed reduction gear 11 is of mechanical type. For example, it may have an epicyclic or planetary train gear. Not illustrated, the speed reduction gear 11 typically comprises a sun gear and a ring gear centered on the longitudinal axis X. It also comprises planet gear meshing with the sun gear and the ring gear. It also includes a planet carrier.

The sun gear is rotationally secured to the low-pressure shaft 8 and forms the input of the speed reduction gear 11, while one or other of the ring gear and the planet carrier, depending on the configuration of the speed reduction gear 11, is rotationally secured to the fan shaft 10 and forms the output of the speed reduction gear 11.

The speed reduction gear 11 allows the fan shaft 10 to be driven at a lower speed than the speed of rotation of the low-pressure shaft 8. This allows to increase the bypass ratio of the turbomachine 1.

The turbomachine 1 also comprises an inter-compressor casing 12 arranged axially, with reference to the longitudinal axis X, between the low-pressure compressor 3 and the high-pressure compressor 4.

The turbomachine 1 may also comprise an inlet casing 13. The inlet casing 13 is arranged axially, with reference to the longitudinal axis X, between the fan 2 and the low-pressure compressor 3.

The turbomachine 1 may also comprise an inter-turbine casing 14. The inter-turbine casing 14 is arranged axially, with reference to the longitudinal axis X, between the high-pressure turbine 6 and the low-pressure turbine 7.

The turbomachine 1 may also include an inter-duct compartment v3 located between the primary duct v1 and the secondary duct v2.

The turbomachine 1 includes accessories or equipment (not shown) such as a fuel pump, a lubrication pump, an electric generator, an electric pump, or a starter.

To drive these accessories, the turbomachine 1 typically comprises an electric machine. It is particularly advantageous for the electric machine to be reversible. The electric machine is thus configured to draw power from a shaft, such as the low-pressure shaft 8 or high-pressure shaft 9, and to inject power into a shaft, such as the low-pressure shaft 8 or high-pressure shaft 9. The electric machine can thus be of the generator type when it is used in a power extraction phase and of the motor type when it is used in a power injection phase.

In order to extract or inject power, the turbomachine typically comprises an accessory drive train 21, also known by the acronym ADT for “Accessory Drive Train”. The accessory drive train 21 includes a gear train comprising a series of toothed wheels meshing together and each assembled coaxially around a respective drive shaft. The toothed wheels of the gear train are driven by drawing mechanical power from the low-pressure or high-pressure shaft 8, 9 for example. The mechanical power taken is transferred to the gear train via drive shafts 22 coupled to one of the drive shafts. The gear train is also coupled to the rotors of accessories or equipment.

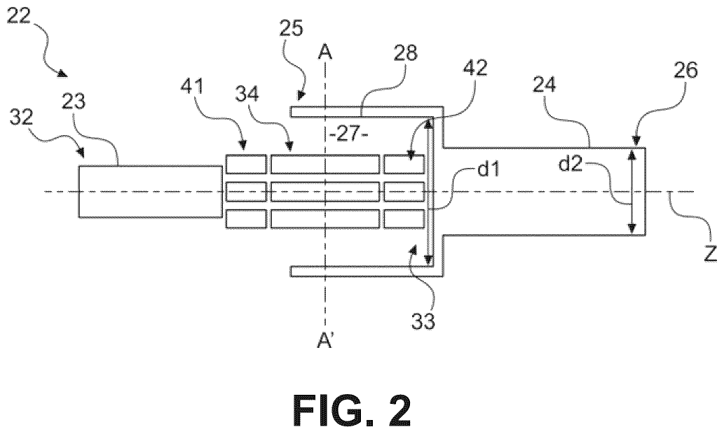

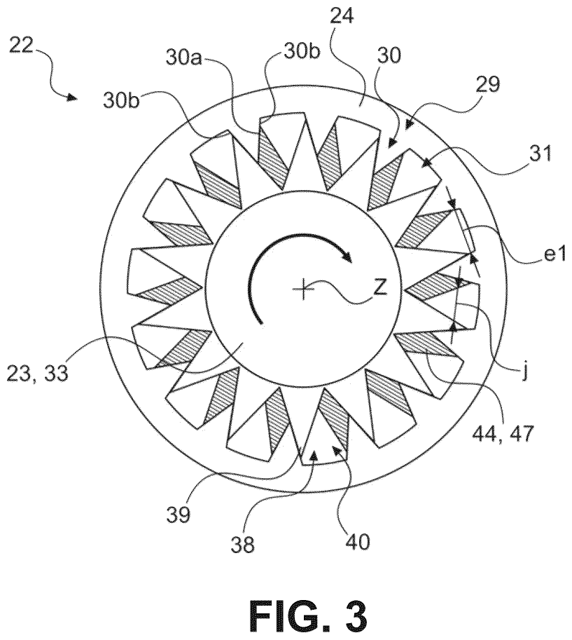

With reference to FIGS. 2 and 3, each drive shaft 22 has a longitudinal axis Z.

In the remainder of the description, the terms “longitudinal” and “longitudinally” refer to the longitudinal axis Z of the drive shaft 22.

The drive shaft 22 comprises a male cylindrical body 23 and a female cylindrical body 24.

Each male and female cylindrical body 23, 24 extends along and around the longitudinal axis Z. Each male and female cylindrical body 23, 24 thus has an elongated shape along the longitudinal axis Z. By “elongated”, it is understood that each male and female cylindrical body 23, 24 has a length as measured along the longitudinal axis Z that is greater than its internal diameter.

The male cylindrical body 23 is mounted coaxially, at least in part, in the female cylindrical body 24. The male cylindrical body 23 cooperates with the female cylindrical body 24 via a spline connection.

The female cylindrical body 24 extends longitudinally between a first end 25 and an opposite second end 26. The first and second ends 25, 26 are annular and centered on the longitudinal axis Z. The first end 25 has a first internal diameter d1 greater than a second internal or external diameter d2 of the second end 26.

The female cylindrical body 24 comprises an internal housing 27. The internal housing 27 is annular and centered on the longitudinal axis Z. In particular, the internal housing 27 is located at the first end 25. The first end 25 is therefore hollow.

The internal housing 27 is delimited by an internal annular splined surface 28.

Referring to FIG. 3, the internal surface 28 has internal splines 29. The internal splines 29 are preferably evenly distributed around the longitudinal axis Z. Each internal spline 29 extends longitudinally along the longitudinal axis Z. Each internal spline 29 thus has an elongated shape along a direction parallel to the longitudinal axis Z. Each internal spline 29 comprises alternating internal teeth 30 and internal grooves 31, around the longitudinal axis Z. Each internal tooth 30 has a top 30a extended by two lateral flanks 30b.

Each internal tooth 30 may have a generally triangular or rectangular profile.

Each internal groove 31 is bounded circumferentially by two adjacent internal teeth 30. The space e1 delimited by two internal teeth defines the width of an internal groove 31.

The male cylindrical body 23 is movable in rotation about the longitudinal axis Z. It extends longitudinally between a first end 32 and an opposite second end 33. The first end 32 may comprise longitudinal splines. The second end 33 is inserted into the internal housing 27 of the female cylindrical body 24. They cooperate with each other via the spline connection.

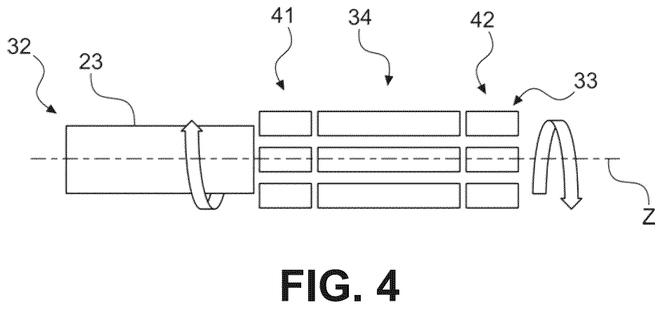

To this end, the drive shaft 22 also comprises a first splined section 34. As can also be seen in FIG. 4, the first section 34 is annular and centered on the longitudinal axis Z. It is located coaxially around the male cylindrical body 23 and is rotationally secured to this male cylindrical body 23. In particular, the first section 34 is located at the second longitudinal end 33 of the male cylindrical body 23. The first section 34 may have a diameter equal to or greater than the diameter of the male cylindrical body 23.

Particularly preferably, the first section 34 and the male cylindrical body 23 form a single piece and are thus made from the same material.

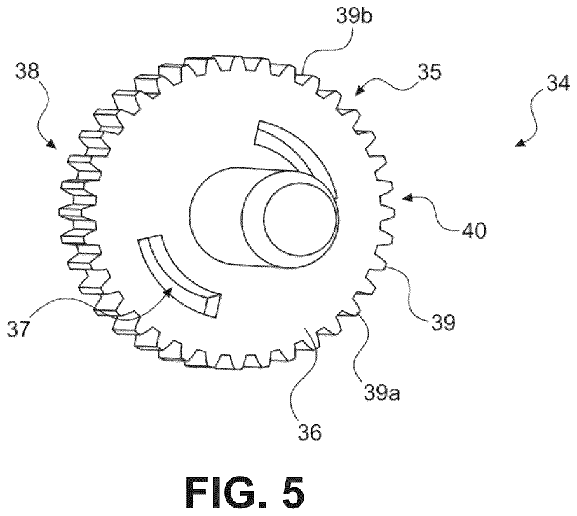

With reference to FIG. 5, the first section 34 comprises a peripheral edge 35 and lateral flanks 36. The peripheral edge 35 is annular and centered on the longitudinal axis Z. The lateral flanks 36 are also annular and centered on the longitudinal axis Z and are located on either side of the peripheral edge 35.

At least one of the lateral flanks 36 may comprise at least one housing 37. Advantageously, at least one of the lateral flanks 36 may comprise two housings 37 which are diametrically opposed along the longitudinal axis Z. Each housing 37 has a curved shape.

The first section 34 also includes first splines 38. The first splines 38 extend longitudinally along the longitudinal axis Z and along the first section 34. The first splines 38 are evenly distributed around the longitudinal axis Z. They are formed, for example, on the peripheral edge 35.

Each first spline 38 comprises alternating first teeth 39 and first grooves 40 around the longitudinal axis Z.

Each first tooth 39 has a top 39a extended by two lateral flanks 39b.

Each first tooth 39 may have a generally triangular or rectangular profile.

Each first groove 40 is bounded circumferentially by two adjacent first teeth 39.

As can be seen in FIG. 3, the first splines 38 on the male cylindrical body 23 cooperate with the internal splines 39 of the female cylindrical body 24. In particular, the first teeth 39 are inserted into the internal grooves 31 of the internal splines 29.

This type of cooperation via splines enables the rotational movement of the male cylindrical body 23 to be transmitted to the female cylindrical body 24. However, the width of the first teeth 39 is less than the width e1 of the internal grooves 31. There is therefore an angular clearance j defined between a first tooth 39 and an adjacent internal tooth 30. This angular clearance is responsible for rattling, dynamic overtorque, and torsional dynamics, which are exacerbated by alternating phases of injection and power withdrawal during which the drive shafts 22 are implemented.

To this end, the drive shaft 22 according to the disclosure also comprises a second splined section 41 and advantageously a third splined section 42.

As shown in FIG. 4, for example, the second and third sections 41, 42 are located coaxially around the male cylindrical body 23 and on either side of the first section 34.

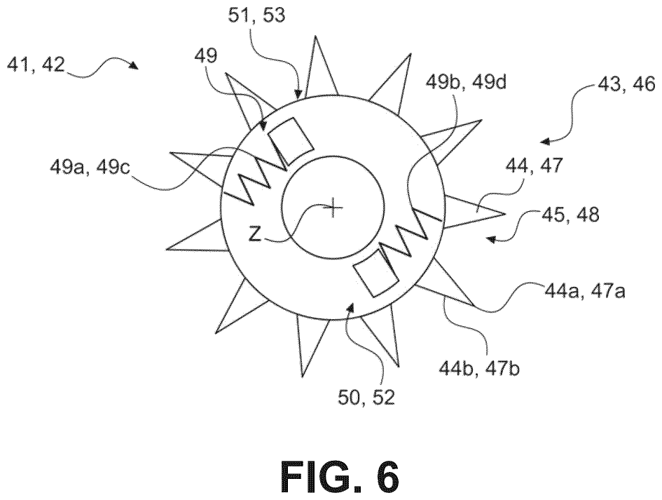

With reference to FIG. 6, the second section 41 is annular and centered on the longitudinal axis Z. It comprises second splines 43. The second splines 43 extend longitudinally along the longitudinal axis Z and along the second section 41. The second splines 43 are evenly spaced around the longitudinal axis Z.

Each second spline 43 comprises alternating second teeth 44 and second grooves 45 around the longitudinal axis Z.

Each second tooth 44 has a top 44a extended by two lateral flanks 44b.

Each second tooth 44 may have a generally triangular or rectangular profile. Preferably, the profile of each second tooth 44 is identical to the profile of the first teeth 39. The number of second teeth 44 is identical to the number of first teeth 39.

Each second groove 45 is bounded circumferentially by two adjacent second teeth 44.

The third section 42 is annular and centered on the longitudinal axis Z. It comprises third splines 46. The third splines 46 extend longitudinally along the longitudinal axis Z and along the third section 42. The third splines 46 are evenly spaced around the longitudinal axis Z.

Each third spline 46 comprises alternating third teeth 47 and third grooves 48 around the longitudinal axis Z.

Each third tooth 47 has a top 47a extended by two lateral flanks 47b.

Each third tooth 47 may have a generally triangular or rectangular profile. Preferably, the profile of each third tooth 47 is identical to the profile of the first teeth 39 and the second teeth 43. The number of third teeth 47 is identical to the number of first teeth 39.

Each third groove 48 is bounded circumferentially by two adjacent third teeth 47.

The second and third sections 41, 42 are movable in rotation about the longitudinal axis X. The second and third sections 41, 42 are movable between a first position and a second position in which the second and third teeth 44, 47 are angularly offset relative to the first teeth 39. By “angularly offset,” it is understood that the teeth have a different circumferential position.

Preferably, the second and third teeth 44, 47 are angularly offset by less than half a pitch relative to the first teeth 39, a pitch being the inter-tooth distance e1 between two adjacent first teeth 39.

To ensure the movement of the second and third sections 41, 42 in rotation around the longitudinal axis X, the drive shaft 22 also includes an elastic means 49 configured to bias the second and third sections 41, 42 into rotation from the first to the second position.

The elastic means 49 comprises, for example, a first spring 49a and, advantageously, a second spring 49b configured to bias the second section 41. The elastic means 49 may comprise third and fourth springs 49c, 49d configured to bias the third section 42. The first and second springs 49a, 49b are arranged in housings 37 in a first lateral flanks 36 of the first section 34. They are diametrically opposed. They mechanically connect the first section 34 to the second section 41. The third and fourth springs 49c, 49d are arranged in the housings 37 in a second lateral flank 36 of the first section 34. They are diametrically opposed. They mechanically connect the first section 34 to the third section 42.

Advantageously, the drive shaft 22 comprises at least one axial abutment 50 connected to the first spring 49a. Advantageously, the drive shaft 22 comprises a second axial abutment 51 connected to the second spring 49b. The first and second axial abutments 50, 51 are diametrically opposed and located in the housing 37.

Advantageously, the drive shaft 22 comprises at least a third axial abutment 52 connected to the third spring 49c and a fourth axial abutment 53 connected to the fourth spring 49d. The third and fourth axial abutments 52, 53 are diametrically opposed and located in the housing 37.

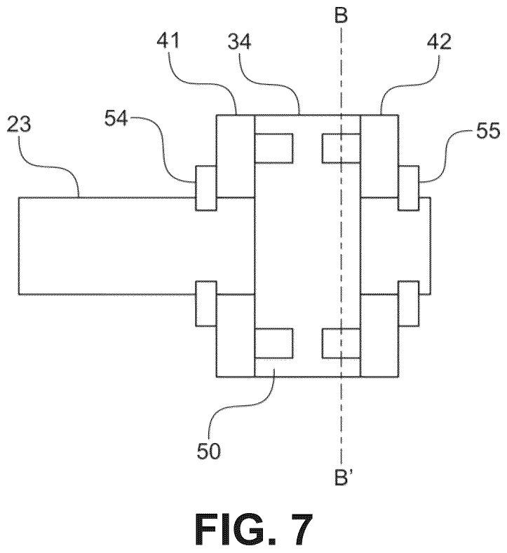

With reference to FIG. 7, the drive shaft 22 may further comprise annular axial stops 54, 55 mounted around the male cylindrical body 23, the second and third sections 41, 42 being located axially between the first section 34 and the axial stops 54, 55 in order to hold the second and third sections in an axial position.

With reference to FIG. 3, when the male cylindrical body 23 is fitted into the female cylindrical body 24, the second teeth 44 and advantageously the third teeth 47 fill the clearance j defined between the first teeth 39 and the internal teeth 30. Advantageously, the second teeth 44 and advantageously the third teeth 47 are pressed against the internal teeth 30.

Thanks to the second section 41 and the elastically deformable means 49, the clearance j between the male and female splines is filled, thus reducing rattling and torque oscillations.

The drive shaft 22 is thus more mechanically robust, particularly when subjected to alternating phases of power injection and withdrawal.

A method for preparing the drive shaft 22 will now be described.

This preparation method comprises the following steps:
(a) providing the male cylindrical body 23 with the first section 34,
(b) assembling the second and optionally third sections 41, 42 around the male cylindrical body 23, on either side of the first section 34,
(c) biasing the resilient means to drive the second and optionally third sections 41, 42 from the first position to the second position.

Advantageously, the second and third sections 41, 42 are driven in rotation about the longitudinal axis Z in opposite directions. This allows torque reversals in both directions of rotation to be anticipated.

A method of mounting the drive shaft 22 will now be described.

This assembly method comprises the following steps:
(a′) preparing the drive shaft according to steps (a) to (c),
(b′) assembling the male cylindrical body 23 into the female cylindrical body 24.

During step (b′), the second teeth 44 and advantageously the third teeth 47 fill the clearance j defined between the first teeth 39 and the internal teeth 30.

While illustrative embodiments have been illustrated and described, it will be appreciated that various changes can be made therein without departing from the spirit and scope of the disclosure.

The embodiments of the invention in which an exclusive property or privilege is claimed are defined as follows:

1. A drive shaft for an aircraft turbomachine, the drive shaft having a longitudinal axis and comprising:
a male cylindrical body extending around and along the longitudinal axis;
a first splined section arranged coaxially around the male cylindrical body and having first longitudinal splines evenly distributed around the longitudinal axis and comprising alternating first teeth and first grooves, the first section being rotationally secured to the male cylindrical body; and
a second splined section arranged coaxially around the male cylindrical body, the second section having second longitudinal splines evenly distributed around the longitudinal axis and comprising alternating second teeth and second grooves, the second section being biased by an elastic element from a first position to a second position in which the second teeth are angularly offset relative to the first teeth.

2. The shaft according to claim 1, wherein the elastic element comprises at least a first spring mechanically connecting the first and second sections.

3. The shaft according to claim 2, wherein the elastic element further comprises a second spring diametrically opposite the first spring and mechanically connecting the first and second sections.

4. The shaft according to claim 2, wherein the first section further comprises an annular lateral flank having at least a first housing configured to receive the first spring.

5. The shaft according to claim 4, wherein the annular lateral flank has a second housing configured to receive the second spring.

6. The shaft according to claim 1, wherein in the second position, the second teeth are angularly offset by less than half a pitch relative to the first teeth, a pitch being the inter-tooth distance between two adjacent first teeth.

7. The shaft according to claim 1, further comprising at least one axial abutment connected to the elastic means.

8. The shaft according to claim 1, further comprising a third section arranged coaxially around the male cylindrical body, the third section having third longitudinal splines distributed around the longitudinal axis and comprising alternating third teeth and third grooves, the first section being arranged axially between the second and third sections, the third section being biased by a second elastic element from a first position to a second position in which the third teeth are angularly offset relative to the first teeth.

9. The shaft according to claim 8, wherein in the second position, the third teeth are angularly aligned with the second teeth.

10. The shaft according to claim 1, further comprising a female cylindrical body having an annular internal housing into which the male cylindrical body is inserted and longitudinal internal splines cooperating with the first and second splines, the internal splines comprising alternating internal teeth and internal grooves, the first teeth being inserted into the internal grooves and the second teeth filling an angular clearance defined between the first teeth and the internal teeth.

11. The shaft according to claim 10, wherein the second teeth are pressed against the internal teeth.

12. A method of preparing a drive shaft according to claim 1, the method comprising the following steps:
(a) providing the male cylindrical body on which the first section is located,
(b) supplying the second section, and
(c) biasing the elastic means to drive the second section from the first position to the second position.

13. A method of assembling a drive shaft, the drive shaft having a longitudinal axis and comprising:
a male cylindrical body extending around and along the longitudinal axis;
a first splined section arranged coaxially around the male cylindrical body and having first longitudinal splines evenly distributed around the longitudinal axis and comprising alternating first teeth and first grooves, the first section being rotationally secured to the male cylindrical body; and
a second splined section arranged coaxially around the male cylindrical body, the second section having second longitudinal splines evenly distributed around the longitudinal axis and comprising alternating second teeth and second grooves, the second section being biased by an elastic element from a first position to a second position in which the second teeth are angularly offset relative to the first teeth, the shaft further comprising a female cylindrical body having an annular internal housing into which the male cylindrical body is inserted and longitudinal internal splines cooperating with the first and second splines, the internal splines comprising alternating internal teeth and internal grooves, the first teeth being inserted into the internal grooves and the second teeth filling an angular clearance defined between the first teeth and the internal teeth,
the method comprising the following steps:
(a′) preparing the drive shaft according to the preparation method of claim 12,
(b′) providing the female cylindrical body, and
(c′) inserting the male cylindrical body into the female cylindrical body, the second teeth filling the clearance defined between the first teeth and the internal teeth.
